(19) United States
(12) Patent Application Publication
(10) Pub. No.: US 2004/0000572 A1
(43) Pub. Date: Jan. 1, 2004

(54) Ticket dispensing apparatus and method

(75) Inventors: William E. Engelhardt JR., Morningview, KY (US); Curtis Woods, Centerville, OH (US)

Correspondence Address: WOOD, HERRON & EVANS, LLP, 2700 CAREW TOWER, 441 VINE STREET, CINCINNATI, OH, 45202, US

(73) Assignee: Interlott Technologies, Inc.

(21) Appl. No.: 10/185,184

(22) Filed: Jun. 28, 2002

(51) Int. Cl. B26F 3/00; B26F 3/02

(52) U.S. Cl. 225/1; 225/100; 225/4

(57) ABSTRACT

An apparatus for dispensing tickets from strips of tickets, wherein each ticket is separable from a respective strip of tickets along a separation line. The apparatus has infeed drive rollers rotatably mounted adjacent respective infeed idler rollers, and infeed drive motors are connected to respective infeed drive rollers. A separator shaft having helical blades mounted thereon is rotatably supported adjacent the infeed drive rollers, and a separator motor is connected to the separator shaft for rotating the helical blades. Exit drive rollers are rotatably mounted adjacent respective exit idler rollers; and an exit drive motor connected to the exit drive rollers and operable to rotate the exit drive rollers.

### FIELD OF THE INVENTION

This invention relates to item dispensers and more particularly, to an apparatus and method for dispensing tickets from strips of tickets.

### BACKGROUND OF THE INVENTION

Various types of machines have been developed for dispensing and vending lottery tickets that are printed in long strips, wherein each ticket is separable from another ticket by a perforation line. The tickets are generally stored in a fan-fold form in a vending machine and are dispensed upon the customer paying for the tickets. The tickets are printed on a relatively heavy stock and hence, have some stiffness but are flexible. The tickets can vary substantially in size and thickness depending on the lottery game, the design by the issuer of the ticket, etc.

Ticket dispensers such as lottery ticket dispensers are often distributed throughout a wide geographic area within which the tickets are sold, and the ticket dispensers are located in a wide range of retail environments. Further, the ticket dispensers may be stand-alone machines with little or no supervision. Therefore, it is important that the ticket dispensers operate very reliably over extended periods of time. A total failure of a ticket dispenser preventing it from dispensing tickets results in a substantial loss of revenue; and in addition, such a failure incurs a substantial cost in having to service the ticket dispenser in the field.

However, partial failures of a ticket dispenser can also be costly. For example, if the vending machine does not separate a ticket exactly along the perforation, important information needed for verification can be separated from the ticket and lost. Needless to say, such a situation is very problematic to the issuer of the lottery ticket as well as the customer. Improper ticket separation can have several causes. For example, with ticket dispensers that are capable of dispensing multiple strips of tickets, individual ticket feed mechanisms include clutches that engage a particular ticket feed device with a common drive motor. While clutches are effective to connect the particular feed device with the common drive motor, clutches by the nature of their construction and operation often have a small amount of slip between the clutch driving member and the clutch driven member. It is important in ticket feed systems that the tickets be fed a precise linear distance in order for the ticket separator to operate properly and reliably. Therefore, any slippage in a clutch that is undetected by a control system can result in an inaccurate ticket feed and a low quality or faulty ticket separation. Further, as clutches age and wear, the tendency for clutch slippage increases, thereby reducing the accuracy of ticket feed.

Another potential cause of improper ticket separation relates to how the ticket feed is detected. The linear ticket feed is often detected by proximity detector or other sensor located within the ticket feeding mechanism. As a ticket tears or is separated from the fanfold, small particles of the ticket material are released and settle within the ticket feeding mechanism and can block the sensor. Thus, such particles can interfere with a proper detection of the ticket by the proximity sensor and result in an erroneous ticket feed.

With some ticket feed mechanisms, a ticket feed device, for example, a feed wheel or roller, may not extend across a full width of the ticket. If tickets having a smaller width are used, such tickets may skew slightly during the feeding process and lose a desired alignment with the separation mechanism. Loss of alignment with the ticket separation mechanism will generally result in an improper ticket separation, that is, a ticket separation that does not occur exclusively along the perforation.

Thus, there is a need for a ticket dispenser that is not only more reliable in operation but also lower in cost.

### SUMMARY OF THE INVENTION

The present invention provides a method and associated ticket dispenser that reliably dispenses tickets over an extended period of time. The ticket dispenser of the present invention provides a reliable feed and separation for tickets of different sizes. Further, the ticket dispenser of the present invention has no sensing devices inside the feed mechanism and therefore, provides a reliable and error free ticket separation. The ticket dispenser of the present invention is especially useful for dispensing lottery tickets.

According to the principles of the present invention and in accordance with the described embodiments, the invention provides an apparatus for dispensing tickets from respective strips of tickets, wherein each ticket is separable from a respective strip of tickets along a separation line. The apparatus has infeed drive rollers rotatably mounted adjacent respective infeed idler rollers, and infeed drive motors are connected to respective infeed drive rollers. A separator shaft having helical blades mounted thereon is rotatably supported adjacent the infeed drive rollers, and a separator motor is connected to the separator shaft for rotating the helical blades. Exit drive rollers are rotatably mounted adjacent respective exit idler rollers; and an exit drive motor is connected to the exit drive rollers. The above dispensing apparatus has an individual feed motor for each of the infeed drive rollers and thus, avoids problems arising from ticket dispensing systems that use clutches and share a common motor.

In another embodiment of the invention, each of the infeed drive motors is connected to a respective infeed drive roller by a drive coupling providing a mechanical advantage to the infeed drive motor. Thus, the infeed drive motor turns through numerous revolutions in order to turn the infeed drive roller through a single revolution. Further, a low resolution encoder is connected to the infeed drive motor and provides a first number of feedback pulses during a single revolution of the infeed drive motor. The low resolution encoder also provides a second number of feedback pulses with respect to each revolution of the infeed drive roller that is equal to the product of the mechanical advantage of the drive coupling times the first number of feedback pulses. In one aspect of this embodiment, the mechanical advantage of the coupling is 30:1 and the first number of feedback pulses is 12. The low resolution encoder is very inexpensive and, in combination with the mechanical advantage of the coupling, provides an accurate and very repeatable positioning of the strip of tickets and a consequential accurate and reliable ticket separation.

In a further embodiment of the invention, the apparatus includes a sensor mounted adjacent the exit drive roller. The sensor provides a feedback signal in response to detecting the ticket. A control is electrically connected to the infeed drive motor and the sensor for controlling the operation of the infeed drive motor in response to the feedback signal. The sensor is located outside of the separator and exit drive roller; and therefore, its exposure to paper dust and particles is minimized. Thus, the sensor will operate reliably over a long period of time with no regular service required.

In a still further embodiment, a method of separating a ticket from a strip of tickets is provided, wherein each ticket is separable from the strip of tickets along a separation line. With the method, the strip of tickets is fed in a forward direction between an infeed drive roller and an infeed idler roller and past a fixed blade of the separator. The feeding of the strip of tickets is stopped to locate the separation line in the strip of tickets downstream or forward of the fixed blade. Next the helical blade is rotated to separate the strip of tickets along the separation line forward of the fixed blade. Locating the separation line forward of the fixed blade provides an accurate and reliable separation operation.

These and other objects and advantages of the present invention will become more readily apparent during the following detailed description taken in conjunction with the drawings herein.

### BRIEF DESCRIPTION OF THE DRAWINGS

FIG. 1 is a perspective view of a ticket feed system in accordance with the principles of the present invention.

FIGS. 2A and 2B are cross-sectional views taken along line 2A-2A of FIG. 1 that illustrate the feeding and bursting of a ticket by the ticket feed system of FIG. 1.

FIG. 3 is a partially broken-away top view and illustrates the construction of the ticket feed system of FIG. 1.

FIG. 4 is a schematic block diagram of a control system for the ticket feed system of FIG. 1.

FIG. 5 is a flowchart illustrating the general steps of a process for initially aligning a strip of tickets in the ticket feed system of FIG. 1.

FIG. 6 is a flowchart illustrating the general steps of a process for dispensing tickets in the ticket feed system of FIG. 1.

### DETAILED DESCRIPTION OF THE INVENTION

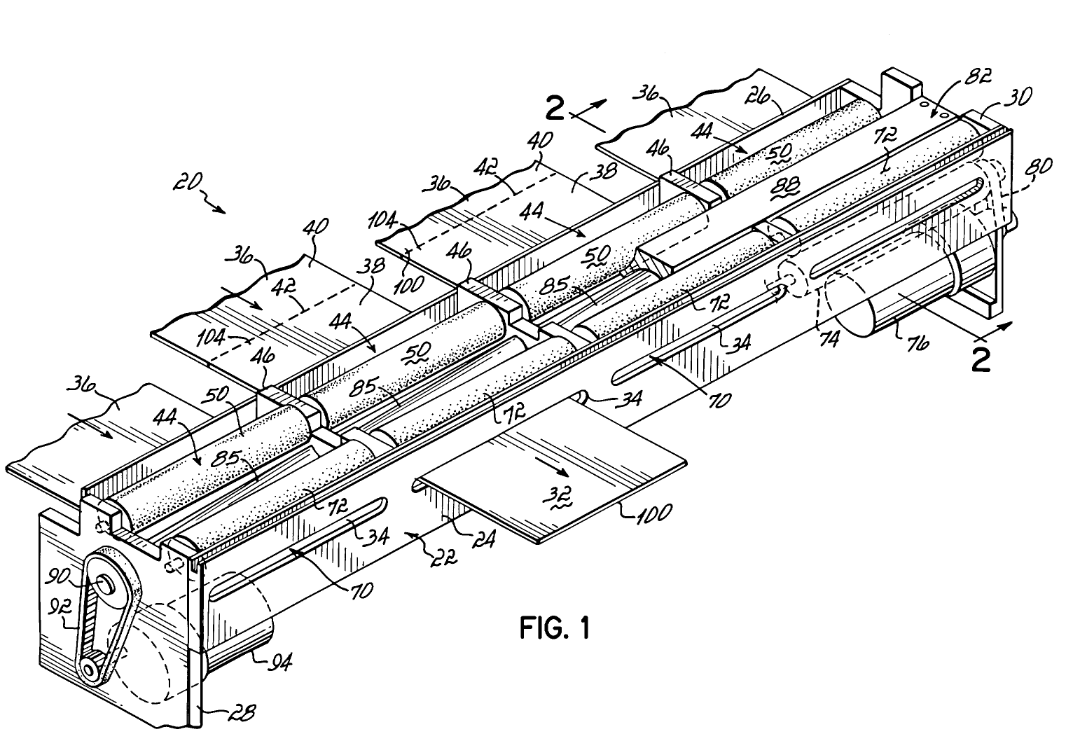

Referring to FIG. 1, a ticket dispensing system 20 has a frame structure 22 that includes a front panel or plate 24 and a substantially parallel rear cover 26 that are mounted at their ends to opposed left and right side plates 28, 30, respectively. The ticket dispensing system 20 may be utilized in any known form of ticket vending machine such as those shown in U.S. Pat. Nos. 4,982,337; 5,222,624; D376,621; U.S. Pat. No. 5,943,241 and D441,227, each of which are hereby incorporated by reference. The front panel 24 and rear cover 26 have a common length that is determined by the number of individual ticket dispensing units 44 that are disposed side-by-side to form the ticket dispensing system 20. The ticket dispensing units 44 may dispense the same or different tickets as desired. The front panel 24 has four ticket dispensing slots 34 from which tickets 32 are dispensed. The strips of tickets 36 are provided to each of the ticket dispensing units 44 of the ticket dispensing system 20, wherein a ticket 32 is separable from another on the strip of tickets 36 by a perforation line 42. Substantially identical internal support brackets 46 extend between the front panel 24 and the rear cover 26 and separate the individual ticket dispensing units 44.

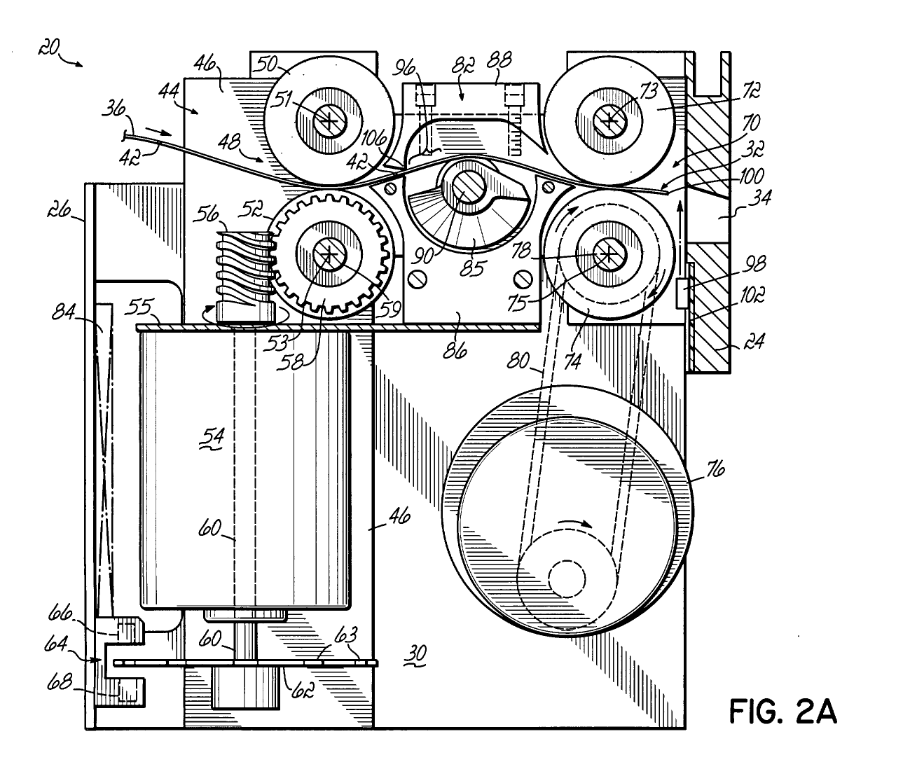

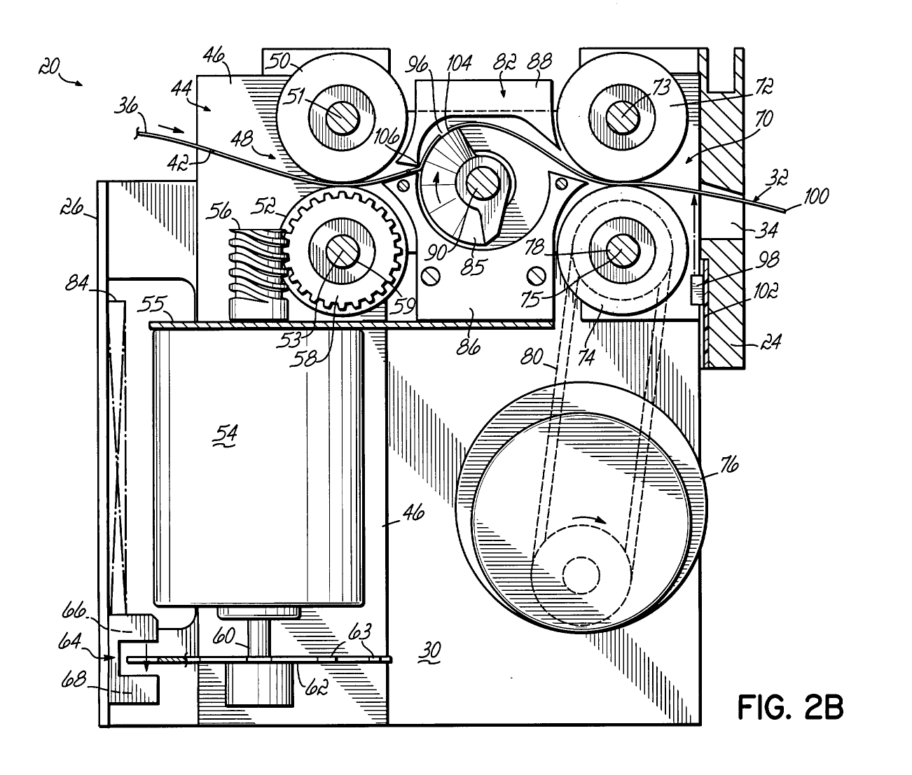

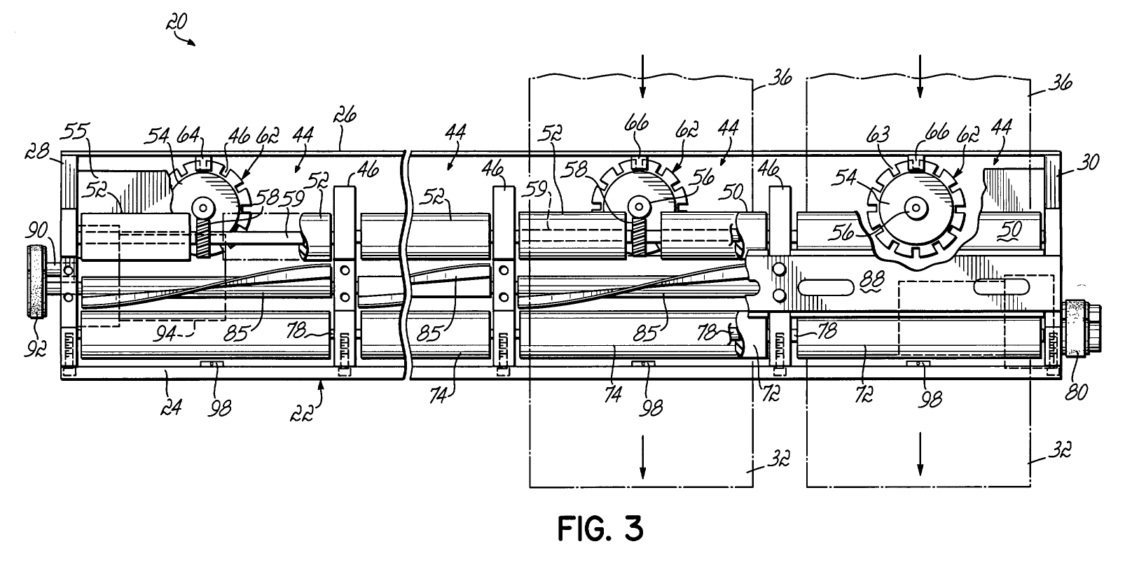

The structure of the ticket dispensing units 44 is substantially identical. Referring to FIG. 2A, the ticket dispensing unit 44 includes an infeed section 48 that has an infeed idler roller 50 that rotates about an axis of rotation 51. An infeed drive roller 52 is mechanically connected to, and driven by, an actuator or motor 54 that is mounted to a motor mounting plate 55. The infeed drive roller 52 rotates about an axes of rotation 53. The infeed idler roller 50 and infeed drive roller 52 combine to form an infeed path therebetween. The motor 54 has an output worm gear 56 that engages a mating gear 58 that is on a common shaft 59 with the infeed drive roller 52. As shown in FIGS. 1 and 3, the infeed idler rollers 50 and infeed drive rollers 52 have respective lengths substantially equal to the widths of the ticket dispensing units 44.

The motor 54 is an electric motor, for example, a DC motor. The gear ratio between the worm gear 56 and the gear 52 is about 30:1. In other words, the infeed drive roller 52 turns one revolution for every 30 revolutions of the worm gear 56. The worm gear 56 is further attached to a motor shaft 60 that supports a segmented wheel 62. The wheel 62 has approximately 12 segments (FIG. 3) and therefore, is capable of generating 12 pulses for each revolution of the motor shaft 60. Thus, with a 30:1 gear ratio with respect to the infeed drive roller 52, the wheel 62 is capable of providing 360 pulses for each full revolution of the infeed drive roller 52. The segmented wheel 62 operates with a segment sensor 64, for example, a proximity detector having an LED light 66 and a light detector 68. Thus, the segmented wheel 62 and segment sensor 64 function as an encoder to provide a plurality of feedback pulses from the detector 68 representative of the angular rotation of the motor 54 and thus, the infeed drive roller 52.

The ticket dispensing unit 44 further comprises an exit section 70 including an exit idler roller 72 that rotates about an axis of rotation 73. An exit drive roller 74 is powered by an exit motor 76 and rotates about an axis of rotation 75. As shown in FIGS. 1 and 3, the exit idler and drive rollers 72, 74 have respective lengths that extend substantially over a full width of the ticket dispensing units 44 and are substantially the same length as the infeed idler and drive rollers 50, 52. The exit idler roller 72 and exit drive roller 74 combine to form an exit feed path therebetween. Further, referring to FIG. 2A, in contrast with the infeed drive rollers 52 that are individually powered by separate drive motors 54, all of the exit drive rollers 74 are connected to a common shaft 78 and are driven in unison via a belt drive 80 connected to the exit drive motor 76.

The infeed idler roller 50 is positioned very close to the infeed drive roller 52. For example, the respective outer circumferential surfaces are separated by a gap of about 0.002 inches along a line connecting the axes of rotation 51, 53 of the respective rollers 50, 52. The exit idler roller 72 is similarly positioned very close to the exit drive roller 74. The rollers 50, 52, 72, 74 are made from a nitrile, urethane rubber compound that has a relatively high coefficient of friction and does not load up with paper during the ticket bursting process. The respective outer surface of the rollers 50, 52, 72, 74 are relatively hard but have some resiliency. Tickets that are fed between the rollers normally have a thickness of about 0.006-0.012 of an inch. Therefore, the close proximity of the idler rollers 50, 72 to respective drive rollers 52, 74 results in the strip of tickets 36 being very firmly gripped by the infeed rollers 50, 52 and the exit rollers 72, 74.

As shown in FIG. 2A, each ticket dispensing unit 44 further comprises a ticket burster section 82. A helical blade 85 is rotatably mounted within lower and upper guides 86, 88, respectively, that extend between internal support brackets 46 that bound the ticket dispensing unit 44. As shown in FIG. 3, the helical blade extends substantially the full length of the ticket dispensing unit 44. Further, each ticket dispensing unit 44 has a helical blade 85 that is mounted on a common shaft 90. As shown in FIG. 1, a belt drive 92 mechanically connects the shaft 90 to a motor 94 that rotates the helical blades 85 in the respective ticket dispensing units 44 in unison.

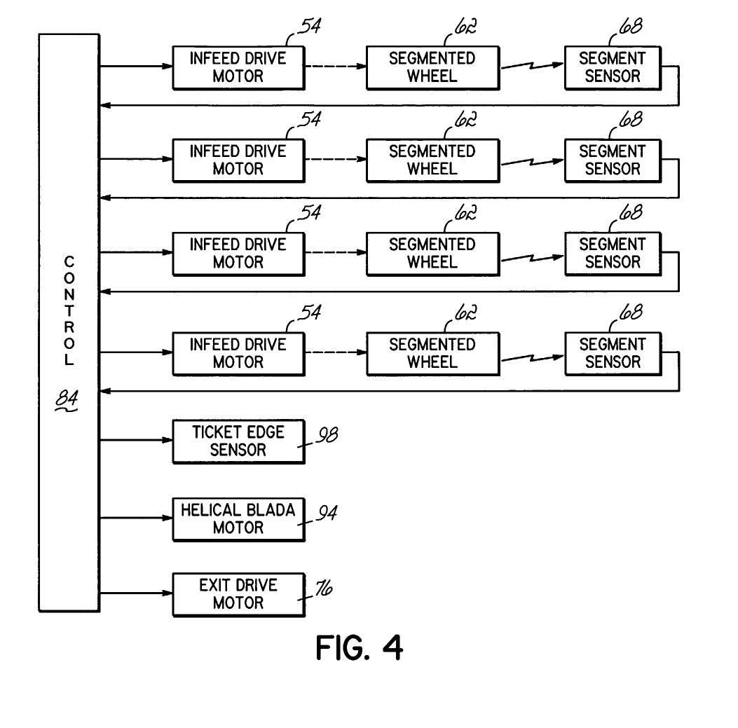

Referring to FIG. 4, the ticket dispensing system is operated by a control 84 that is electrically connected to the motors 54, 76, 94, the segment sensor 64 and an edge sensor 98. The control 84 may be any suitable controller, for example, a programmable logic controller. The control 84 may be connected to various user operable input devices in a known manner, for example, pushbuttons, etc., as well as various sensory perceptible output devices, for example, lights, a visual display such as an LCD screen, etc. The control 84 may also be connected to another control via a bus (not shown) that may provide the control 84 instructions regarding its operation. Either the control 84 or another control can determine the length of a ticket feed displacement as a function of a length of the ticket and the number of tickets purchased. Further, the control 84 can utilize feedback pulses from the segment sensor 64 to precisely control the operation of the motor 54.

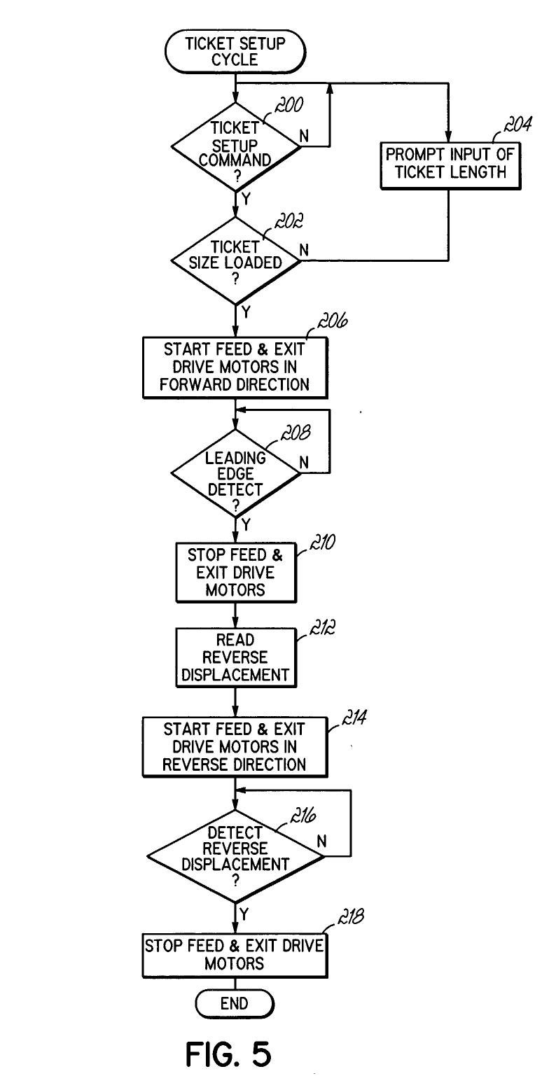

In use, as will be appreciated, the ticket dispensing system 20 is mounted within a ticket vending machine (not shown) that provides storage bins for the ticket strips, bill and change acceptors to execute a ticket purchasing transaction, etc. At different times, strips of tickets must be loaded in the ticket vending machine and the ticket dispensing system 20. After gaining access to the interior of the ticket vending machine, strips of tickets are placed in storage bins in a known manner; and an end of a strip of tickets is manually placed adjacent the infeed idler and drive rollers 50, 52. Thereafter, a pushbutton or switch is operated to command an execution of a ticket setup cycle. Referring to FIG. 5, the control 84 first detects, at 200, a ticket setup command and thereafter, determines, at 202, whether the ticket length or size is loaded. If not, the control 84 prompts, at 204, the user to input the ticket length. If the ticket length is available, the control 84 provides, at 206, output signals to command the feed and exit drive motors 54, 76 to rotate in the forward direction, that is, in a direction that moves the strip of tickets 36 toward the front panel 24. Operating the drive motors 54, 76 causes the strip of tickets 36 to feed between the infeed idler and drive rollers 50, 52, over the helical blade 85 and between the exit idler and drive rollers 72, 74. As the leading edge 100 of the ticket 32 approaches the front panel 24, the leading edge 100 is detected by the edge sensor 98. The edge sensor 98 is mounted on a printed circuit board 94 that, in turn, is attached to the rear or inner side of the front panel 24. The edge detector 98 may be any known device, for example, an LED and a sensor that detects light from the LED. Upon the control 84 detecting, at 208, a change of state of an input signal from the edge detector 98 representing a detection of the leading edge 100, the control 84 provides, at 210, an output signal commanding the feed and exit drive motors to stop.

The control 84 then reads, at 212, a stored reverse displacement value. The reverse displacement is the distance the strip of tickets 36 must be moved in the reverse direction to place the leading edge 100 at a desired perforation location 96. The reverse direction moves the strip of tickets 36 away from the front panel 24 toward the rear cover 26. The perforation location 96 is displaced in the forward direction from a fixed blade or edge 106 that is on the upper guide 88. The perforation location 96 is a location that is determined experimentally and is a location at which the helical blade 85 most reliably separates the ticket 32 from the strip of tickets 36 along the perforation 42. The perforation location 96 is a measurable, fixed distance from the location of the fixed edge sensor 98. That distance was previously entered into the control 84 by the manufacturer of the ticket dispensing system 20 and is recallable by the control 84 as the reverse displacement.

There is a range of locations for the perforation location 96 with respect to the fixed blade 106, and the limits of that range can be determined experimentally. For example, if the perforation location 96 is moved upstream of the fixed blade 106, operation of the helical blade 85 results in the strip of tickets 36 tearing at a location other than the perforation 42. A similar situation can be produced if the perforation is moved too far downstream in the forward direction from the fixed blade 106. Further, the range of acceptable perforation locations 96 also varies depending on the physical characteristics of the perforation, the ticket substrate material and construction, the ticket thickness, etc. For many commonly used tickets, the perforation location 96 is about 0.100 of an inch downstream of, or in the forward direction from, the fixed blade 106. For those same commonly used tickets, the perforation location 96 can range in the forward direction to a location about 0.250 of an inch downstream of the fixed blade 106.

After reading the reverse displacement, the control 84 then, at 214, starts the feed and exit drive motors 54, 76 in the reverse direction. As the drive motor 54 rotates, the segment sensor 64 is providing a train of signal pulses back to the control 84. Each signal pulse corresponds to a segment 63 passing the segment sensor 62, and thus, each signal pulse represents an increment of rotation, for example, 1° of rotation, of the infeed drive roller 52. Each degree of angular rotation of the infeed drive roller 52 results in the strip of tickets 36 being fed through an increment of linear displacement or a fixed distance that is a function of the radius of the infeed drive roller 52. Therefore, the control 84, by counting the pulses received from the segment sensor 64, is able to track the distance the strip of tickets 36 is being moved in the reverse direction by the infeed drive motor 54. When the control 84 detects, at 216, that the leading edge 100 of the ticket 32 has moved through a distance substantially equal to the reverse displacement, the control 84 then provides, at 218, output signals commanding the infeed and exit drive motors 54, 76 to stop. When the infeed drive motor 54 stops, the leading edge 100 of the ticket 32 is located at the perforation location 96.

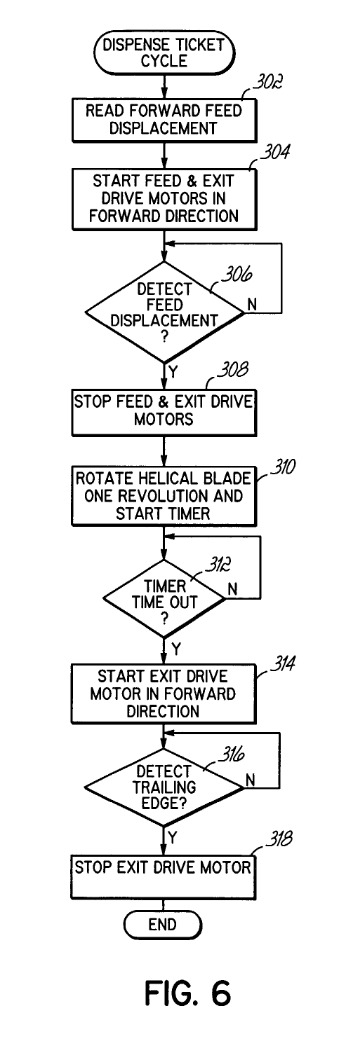

After all of the ticket dispensing units 44 have been properly loaded with strips of tickets 36, the ticket vending machine is then placed into service. Customers purchase desired tickets using the ticket vending machine in a known manner. When the control 84 receives a signal or senses a flag that a ticket is to be dispensed, it executes a dispense ticket cycle as illustrated in FIG. 6. The control 84 first reads, at 302, a forward feed displacement value that is determined by the length of each ticket 32 and the number of tickets purchased. The displacement can be determined by the control 84 in real time and placed in a buffer store or the forward feed displacement can be determined by a separate control and transmitted to the control 84 via a bus or other communication link. The purpose of the forward feed displacement is to place a perforation at the perforation location 96, so that when the perforation is separated, a purchased number of tickets is dispensed from the ticket dispensing unit 44.

Given the forward feed displacement, the control 84 then provides, at 304, output signals commanding operation of the appropriate infeed drive motor 54 and the exit drive motor 76 in the forward direction. While those motors are operating, the control 84 is, again, counting pulses provided from the segment sensor 64. When the control 84 detects, at 306, a number of pulses that provides a ticket feed substantially equal to the forward feed displacement, the control 84 then provides, at 308, output signals commanding the appropriate infeed drive motor 54 and exit motor 76 to stop.

Next, the control 84 provides, at 310, an output signal commanding the helical blade motor 94 to rotate the helical blade 85 through one full revolution. At the same time, the control 84 starts an internal timer. The time period of the timer is set to be slightly longer than the time required for the helical blade to be rotated through the one revolution. As the helical blade rotates clockwise as viewed in FIG. 2B, it lifts the strip of tickets 36 that is securely held between the infeed idler and drive rollers 50, 52 and the exit idler and drive rollers 72, 74. If the perforation location 96 has been properly determined, rotation of the helical blade 85 causes the strip of tickets to separate at the perforation 42, thereby separating one or more tickets from the strip of tickets 36. Upon the control 84 detecting, at 312, that the timer has timed out, it then provides, at 314, output signals commanding the exit feed motor 76 to operate in the forward direction. That operation feeds the separated one or more tickets through the ticket dispensing slot 34. The ticket feed continues until the control 84 detects, at 316, a change of state of the input signal from the edge sensor 98. That change of state is caused by the trailing edge 104 of the ticket 32 passing the edge sensor 98. Thereafter, the control 84 provides, at 318, an output signal commanding the exit drive motor 76 to stop, thereby completing a ticket dispensing cycle.

Alternatively to detecting the trailing edge, the control can operate an internal timer that is set to a period of time substantially equal to the time required for the trailing edge 104 of the ticket to reach the exit drive roller 74. When the exit drive motor 76 is stopped, the trailing edge of the ticket is still in the exit feed path between the exit idler roller 72 and the exit drive roller 74, but the leading edge 100 of the ticket extends through the dispensing slot 34 of the front panel 24. Therefore, the purchaser of the ticket is able to manually pull the ticket from between the exit idler roller 72 and the exit drive roller 74.

The above-described ticket dispensing system reliably dispenses tickets from a perforated strip of tickets over an extended period of time. The long term reliability is attributable to several factors. First, each ticket dispensing unit 44 includes its own infeed motor 54. Thus, problems arising from ticket dispensing systems that use clutches and share a common motor are eliminated.

Second, each of the motors 54 has a closed loop positioning system that utilizes an inexpensive but reliable feedback device. The twelve-segment wheel 62 is very inexpensive and, in combination with the gear ratio of the worm gear drive, provides a positioning system that controls the operation of the infeed drive roller with 1° of resolution. That capability is able to provide an accurate and very repeatable positioning of either the leading edge of the ticket or ticket perforations with an advantage of accurately and reliably separating the tickets along the perforation line.

Third, the reliability of the ticket feed is further assisted by the diameter and length of the rollers 50, 52, 72, 74. The rollers have a relatively large diameter and have a length substantially equal to the width of the ticket dispensing unit 44. Such a large roller provides a relatively large footprint on the ticket, that is, the area of contact of the roller on the ticket. The large roller foot print has an advantage of repeatably and reliably feeding tickets of different widths. During the ticket separation process, the tickets are more firmly secured by the larger roller footprint between the infeed rollers 50, 52 and the exit rollers 72, 74. Thus, the ticket strip 36 does not slip during a rotation of the helical blade 85, and reliable ticket separation is provided over hundreds of thousands of cycles. The large footprint also permits the idler rollers to be separated slightly from the drive rollers, thereby minimizing roller wear but still providing a reliable ticket feed therebetween.

The reliability of the ticket dispensing unit 44 is further enhanced by the absence of any sensors between the infeed rollers 50, 52 and the exit rollers 72, 74. During the separation process, as the helical blade separates the ticket strip into two pieces along the perforation line, paper particles are separated from the ticket strip and collect in the ticket dispensing unit 44 between the infeed rollers 50, 52 and the exit rollers 72, 74. The collection of such paper dust and particles adversely impacts the operation of any sensors that may be located in that area. The edge sensor 98 is located outside of that area and near the dispensing slot 34 and therefore, its exposure to paper dust and particles is minimized.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. For example, the low resolution encoder formed by the segmented wheel 62 and segment detector 64 uses a wheel 62 having 12 segments 63. As will be appreciated, in alternative embodiments, the number of segments 63 may vary along with the mechanical advantage of the worm gear 56, for example, using a 24 segment wheel would double the positioning resolution of the system. The exact number of segments 63 is not important. What is important is the fact that relatively precise positioning of the infeed drive roller 52 is achieved using a very inexpensive low resolution encoder. That cost benefit is multiplied by the fact that multiple, that is, four, encoders are required. Using four high resolution encoders would substantially adversely impact the cost of the ticket dispensing system 20.

In the described embodiment, a worm gear 56 is used to couple the motor 54 to the infeed drive roller 50. As will be appreciated, in alternative embodiments, other known gearing mechanisms or mechanical coupling systems may be used to connect the motor 54 to the infeed drive roller 50.

Further, in the described embodiment, the edge sensor 98 is located on an inner surface of the front panel 24. As will be appreciated, in alternative embodiments, the edge sensor 98 may be placed below the front panel and detect an edge that passes over a hole in the front panel aligned with the edge detector. In other embodiments, the edge detector 98 can be placed on an outer forward surface of the front panel 24.

Therefore, the invention in its broadest aspects is not limited to the specific details shown and described. Consequently, departures may be made from the details described herein without departing from the spirit and scope of the claims which follow.

What is claimed is:

1. An apparatus for dispensing tickets from respective strips of tickets, wherein each ticket is separable from a respective strip of tickets along a separation line, the apparatus comprising:
rotatable infeed idler rollers;
infeed drive rollers rotatably mounted adjacent respective infeed idler rollers;
infeed drive motors, each of the infeed drive motors being connected to a different one of the infeed drive rollers and operable to rotate the one of the infeed drive rollers;
a separator shaft having helical blades mounted thereon and being rotatably supported adjacent the infeed drive rollers;
a separator motor mechanically connected to the separator shaft and operable to rotate the helical blades;
exit idler rollers rotatably mounted adjacent the separator shaft;
exit drive rollers rotatably mounted adjacent respective exit idler rollers; and
an exit drive motor connected to the exit drive rollers and operable to rotate the exit drive rollers.

2. The apparatus of claim 1 wherein the infeed drive roller and infeed idler roller have a substantially common length.

3. The apparatus of claim 2 wherein the exit drive roller and exit idler roller have a substantially common length.

4. The apparatus of claim 1 wherein the infeed drive roller does not contact the infeed idler roller.

5. The apparatus of claim 5 wherein the exit drive roller does not contact the exit idler roller.

6. The apparatus of claim 4 wherein the infeed drive roller is separated from the infeed idler roller by about 0.002 of an inch, and the exit drive roller is separated from the exit idler roller by about 0.002 of an inch.

7. The apparatus of claim 1 further comprising a proximity detector mounted forward of the exit idler roller and the exit drive roller and positioned to detect a leading edge of the ticket.

8. The apparatus of claim 1 further comprising:
drive couplings, each drive coupling mechanically connecting one of the infeed drive motors to a respective infeed drive roller, each drive coupling providing a mechanical advantage such that an infeed drive motor turns through many revolutions in order to turn the infeed drive roller through a single revolution; and
low resolution encoders, each of the low resolution encoders mechanically connected to a different one of the infeed drive motors and providing a first number of feedback signals during a single revolution of a respective infeed drive motor, and each of the low resolution encoders providing a second number of feedback signals with respect to each revolution of a respective infeed drive roller equal to the product of the mechanical advantage of a respective drive coupling times the first number of feedback signals.

9. An apparatus for dispensing a ticket from a strip of tickets, wherein each ticket is separable from the strip of tickets along a separation line, the apparatus comprising:
a rotatable infeed idler roller;
an infeed drive roller rotatably mounted adjacent the infeed idler roller;
an infeed drive motor;
a drive coupling mechanically connecting the infeed drive motor to the infeed drive roller, the drive coupling providing a mechanical advantage to the infeed drive motor such that the infeed drive motor turns through numerous revolutions in order to turn the infeed drive roller through a single revolution;
a low resolution encoder mechanically connected to the infeed drive motor and providing a first number of feedback pulses during a single revolution of the infeed drive motor, the low resolution encoder providing a second number of feedback pulses with respect to each revolution of the infeed drive roller equal to the product of the mechanical advantage of the drive coupling times the first number of feedback pulses;
a separator rotatably mounted adjacent the infeed drive roller;
a separator motor mechanically connected to the separator and operable to rotate the separator;
an exit idler roller rotatably mounted adjacent the separator;
an exit drive roller rotatably mounted adjacent the exit idler roller; and
an exit drive motor connected to the exit drive roller and operable to rotate the exit drive roller.

10. The apparatus of claim 9 wherein the low resolution encoder comprises:
a segmented wheel; and
a segment detector mounted adjacent the segmented wheel and providing a feedback pulse for each segment of the segmented wheel that passes the segment detector.

11. The apparatus of claim 10 wherein the segmented wheel has less than 100 segments.

12. The apparatus of claim 10 wherein the segmented wheel has 12 segments.

13. The apparatus of claim 9 wherein the second number of feedback pulses is 360.

14. The apparatus of claim 10 wherein the first number of feedback pulses is 12, and the mechanical advantage is 30:1.

15. An apparatus for dispensing a ticket from a strip of tickets, wherein each ticket is separable from the strip of tickets along a separation line, the apparatus comprising:
a rotatable infeed idler roller;
an infeed drive roller rotatably mounted adjacent the infeed idler roller;
an infeed drive motor connected the infeed drive roller and operable to rotate the infeed drive roller;
a separator rotatably mounted adjacent the infeed drive roller;
a separator motor mechanically connected to the separator and operable to rotate the separator;
a exit idler roller rotatably mounted adjacent the separator;
an exit drive roller rotatably mounted adjacent the exit idler roller;
an exit drive motor connected to the exit drive roller and operable to rotate the exit drive roller;
a sensor mounted adjacent the exit drive roller, the sensor providing a feedback signal in response to detecting the ticket; and
a control electrically connected to the infeed drive motor and the sensor for controlling the operation of the infeed drive motor in response to the feedback signal.

16. The apparatus of claim 15 wherein the control is electrically connected to the separator motor and the exit drive motor.

17. A method of controlling a feed of a strip of tickets, wherein each ticket is separable from a respective strip of tickets along a separation line, the method comprising:
feeding the strip of tickets in a forward direction with an infeed drive roller, past a separator;
detecting a leading edge of the strip of tickets being fed to a first location forward of the separator and adjacent the exit drive roller;
stopping the feeding of the strip of tickets in the forward direction in response to detecting the leading edge of the first ticket being fed to the first location;
feeding the strip of tickets in a reverse direction through a displacement placing the leading edge of the first ticket at a perforation location forward of a fixed blade of the separator.

18. The method of claim 17 further comprising operating a helical blade to separate the strip of tickets at the perforation location.

19. The method of claim 17 further comprising initiating operation of an infeed drive motor in the forward direction to feed the strip of tickets between an infeed idler roller and an infeed drive roller connected to the infeed drive motor.

20. The method of claim 19 further comprising terminating operation of the infeed drive motor in response to detecting the leading edge of the first ticket.

21. The method of claim 20 further comprising after terminating operation of the infeed drive motor, initiating operation of an infeed drive motor in the reverse direction to feed the strip of tickets in the reverse direction between an infeed idler roller and an infeed drive roller.

22. The method of claim 21 further comprising terminating operation of the infeed drive motor in response to detecting the strip of tickets moving through a fixed reverse displacement.

23. A method of separating a ticket from a strip of tickets, wherein each ticket is separable from the strip of tickets along a separation line, the method comprising:
feeding the strip of tickets in a forward direction between an infeed drive roller and an infeed idler roller and past a fixed blade of a separator;
stopping the feeding of the strip of tickets to locate the separation line in the strip of tickets forward of the fixed blade; and
rotating a helical blade to separate the strip of tickets along the separation line forward of the fixed blade.

24. The method of claim 18 further comprising stopping the feeding of the strip of tickets after the separation line has moved to a location about 0.100 of an inch forward of the fixed blade.

25. The method of claim 18 further comprising stopping the feeding of the strip of tickets after the separation line has moved to a location a range of about 0.000-0.250 of an inch forward of the fixed blade.

26. An apparatus for dispensing tickets from a strip of tickets, wherein each ticket is separable from the strip of tickets along a separation line, the apparatus comprising:
a rotatable infeed idler roller;
an infeed drive roller rotatably mounted adjacent the infeed idler roller;
an infeed drive motor connected to the infeed drive roller and operable to rotate the infeed drive roller;
a separator shaft having a helical blade mounted thereon and being rotatably supported adjacent the infeed drive roller;
a separator motor mechanically connected to the separator shaft and operable to rotate the helical blade;
an exit idler roller rotatably mounted adjacent the separator shaft;
an exit drive roller rotatably mounted adjacent the exit idler roller, the infeed idler roller, the infeed drive roller, the exit idler roller and the exit drive roller having a common length with the helical blade; and
an exit drive motor connected to the exit drive roller and operable to rotate the exit drive roller.
